(19) United States
(12) Patent Application Publication
(10) Pub. No.: US 2006/0002648 A1
(43) Pub. Date: Jan. 5, 2006

(54) Tapered roller thrust bearing with favorable load distribution

(76) Inventors: Patrick Tibbits, Valparaiso, IN (US); John A. Morgart, Kouts, IN (US); Christopher Vas, Westville, IN (US)

Correspondence Address: McDonnell Boehnen Hulbert & Berghoff LLP;32nd Floor, 300 S. Wacker Drive, Chicago, IL, 60606, US

(21) Appl. No.: 10/882,870

(22) Filed: Jul. 1, 2004

(51) Int. Cl. F16C 33/58; F16C 29/04

(52) U.S. Cl. 384/622

(57) ABSTRACT

A tapered roller thrust bearing with more optimally distributed loading on each tapered rolling element to reduce maximum tapered roller contact stress in a cost effective and efficient manner is provided. The bearing may include an upper plate, a bottom plate having a bottom surface, and a plurality of tapered rolling elements, where the interface between the bottom surface of the bottom plate and a top surface of a bearing support is such that some of the loading on the tapered rolling elements is moved radially outwardly on the bearing to a region of larger cross-sectional diameter of the tapered rolling elements. This may be accomplished by appropriately tapering the bottom surface of the bottom plate of the bearing, by appropriately tapering the top surface of the bearing support, or a combination of the two.

### FIELD OF THE INVENTION

This present invention relates to bearings in general, and in particular, to a thrust bearing assembly including tapered rolling elements and a support structure.

### BACKGROUND OF THE INVENTION

A bearing is generally a device used to reduce friction between moving surfaces and to support moving loads. One common type of bearing is a tapered roller thrust bearing. A tapered roller thrust bearing reduces friction to allow relative movement of two bodies in the presence of an applied thrust load (i.e. a load applied along the axis of a shaft). Thus, thrust bearings allow for the rotation of a shaft under a load applied axially, along the axis of the shaft. Tapered roller thrust bearings typically include an upper plate with an upper race, a bottom plate with a bottom race, and tapered rolling elements in the shape of truncated cones disposed between the upper and bottom races. The tapered rolling elements rotate within the upper and bottom races. More specifically, the bottom race comprises a roller path positioned within the bottom plate at its inside surface, and the upper race comprises a roller path positioned within the upper plate at its inside surface. The rolling elements assist in distributing the load and reducing friction through the movement of the rolling elements, which roll freely around the races. One of the plates is often attached to a rotating shaft, and the other plate is often attached to a support structure. In a particular application of a tapered roller thrust bearing, the bottom plate is attached to the shaft through a backup plate, which abuts a bottom surface of the bottom plate. The bottom of the backup plate in turn abuts a lockring, which prevents the backup plate from sliding axially along the shaft.

Typically, tapered rolling element thrust bearings attempt to transfer a thrust load between the upper and bottom races, while allowing a shaft to rotate about its axis. This transfer of thrust load occurs by distributing the load substantially equally among the tapered rolling elements in the bearing. However, the load distribution between each tapered rolling element and the upper and bottom races is not uniform along the rolling element's line of contact with each race. Such non-uniformity in load distribution along the lines of contact for the tapered rolling elements causes points of higher loading to occur in each element, potentially leading to a larger maximum stress on the tapered rolling element.

The problem is further exacerbated by deflection in the structure that supports the bearing when the shaft applies a thrust load to the bearing. This deflection causes the load distribution of each tapered rolling element along its lines of contact with the upper and bottom races to move radially inward on the bearing toward an area of smaller cross-sectional diameter of the tapered rolling elements. Because a load applied to a tapered rolling element at a location having a smaller cross-sectional diameter results in a higher contact stress than the same load applied at a location having a larger cross-sectional diameter, the shifted load distribution along the lines of contact of each tapered rolling element increases the peak contact stresses acting on the tapered rolling elements. The increased peak contact stresses can undesirably reduce the life of the bearing and the maximum load it can carry. Therefore, shifting the maximum loading on the tapered rolling elements of a thrust bearing toward a location having a larger tapered rolling element cross-sectional diameter, or radially outward, provides for increased maximum load support capability and increased life for a rolling element bearing.

Thus, there is a need for a bearing that can more optimally distribute loading along the lines of contact of the tapered rolling elements with the upper and bottom races radially outwardly to locations having a larger tapered rolling element cross-sectional diameter to reduce the maximum contact stress on the rolling elements.

### SUMMARY OF THE INVENTION

The present embodiments provide the capability of more optimally distributing a load on the rolling elements of a tapered roller thrust bearing to reduce maximum rolling element contact stress in a cost effective and efficient manner. The present embodiments are illustrated as exemplary embodiments that disclose a system for reducing the maximum contact stress on the rolling elements of a tapered roller thrust bearing.

In an aspect of the present embodiment, a tapered roller thrust bearing is provided and generally includes an upper plate, a bottom plate, and a plurality of tapered rolling elements. The upper plate includes an upper race, and the bottom plate has a bottom race and a bottom surface. Each of the plurality of tapered rolling elements has a rolling surface, a first end, and a second end, and each are disposed between the upper race and the bottom race. The bottom surface of the bottom plate is tapered at an angle α so that the interface between the bottom surface of the bottom plate and a bearing support is such that a portion of a thrust load acting on the rolling surface of the plurality of tapered rolling elements is moved radially outwardly toward the second end of each of the plurality of tapered rolling elements.

In another aspect of the present embodiment, a bearing assembly is provided and generally includes an upper plate, a bottom plate, a plurality of tapered rolling elements, and a bearing support. The upper plate includes an upper race, and the bottom plate has a bottom race and a bottom surface. Each of the plurality of tapered rolling elements has a rolling surface, a first end, and a second end, and each are disposed between the upper race and the bottom race. The bearing support includes a top surface that contacts the bottom surface of the bottom plate. The bottom surface of the bottom plate is tapered at an angle α, and the top surface of the bearing support is tapered at an angle β so that the interface between the bottom surface of the bottom plate and the top surface of the bearing support is such that a portion of a thrust load acting on the rolling surface of the plurality of tapered rolling elements is moved radially outwardly toward the second end of each of the plurality of tapered rolling elements.

In another aspect of the present embodiment, a bearing support is provided and generally includes a backup plate having a top surface. The top surface of the backup plate is tapered at an angle β so that the interface between a bottom surface of the bottom plate of the tapered roller thrust bearing and the top surface of the backup plate is such that a portion of a thrust load acting on a rolling surface of a plurality of tapered rolling elements is moved radially outwardly toward the second end of each of the plurality of tapered rolling elements.

The present embodiments provide the ability to more optimally distribute the load along a tapered rolling element's lines of contact with the upper and bottom races of a tapered roller thrust bearing. This improved distribution of loading results in a portion of the load along the tapered rolling element lines of contact to be moved radially outwardly toward a location of larger tapered rolling element cross-sectional diameter for each of the plurality of tapered rolling elements. This shifted load distribution reduces the maximum tapered rolling element contact stress, which improves the fatigue life of the bearing.

The foregoing and other objects, features and advantages of the bearing, backup plate, or bearing assembly will be apparent from the following more particular description of preferred embodiments as illustrated in the accompanying drawings.

### BRIEF DESCRIPTION OF THE DRAWINGS

FIG. 1 is an exploded view of a tapered roller thrust bearing positioned on a shaft;

FIG. 2 is a cross-sectional view of a tapered roller thrust bearing positioned on a shaft;

FIG. 3 is a cross-sectional view illustrating a tapered roller thrust bearing positioned on a shaft with attached support structures, where the bottom surface of the bottom plate of the bearing is tapered in accordance with an exemplary embodiment of the present invention;

FIG. 4 is a cross-sectional view of a tapered roller thrust bearing positioned on a shaft with attached support structures, where the top surface of the backup plate is tapered in accordance with an exemplary embodiment of the present invention;

FIG. 5 is a cross-sectional view of a tapered roller thrust bearing with an attached shaft and attached support structures with the bottom surface of the bottom plate of the bearing and the top surface of the backup plate both being tapered in accordance with an exemplary embodiment of the present invention;

FIG. 6A is a cross-sectional, partial view of a bottom plate of a bearing, where the bottom surface is shown tapered at an angle α;

FIG. 6B is a cross-sectional, partial view of a backup plate where the top surface of the backup plate is shown tapered at an angle β;

FIG. 7 is a graphical cross-sectional representation of the results of a finite element method analysis of loading on a tapered rolling element of a tapered roller thrust bearing in which the bottom plate receives rigid support;

FIG. 8 is a graphical cross-sectional representation of the results of a finite element method analysis of loading on a tapered rolling element of a typical tapered roller thrust bearing in which the bottom plate receives imperfectly rigid support;

FIG. 9 is a graphical cross-sectional representation of the results of a finite element method analysis of loading on a tapered rolling element of a tapered roller thrust bearing in which the bottom plate receives imperfectly rigid support, and in which the taper applied to the backup plate compensates for the lack of rigid support in accordance with an exemplary embodiment of the present invention;

FIG. 10 is a graph illustrating tapered roller load versus radial distance from the center of the bearing for a tapered roller thrust bearing with various types of bearing supports;

FIG. 11A is a two-dimensional graphical representation of the conical surface, line of contact, and plane of transverse curvature for a tapered roller thrust bearing in accordance with an exemplary embodiment;

FIG. 11B is a three-dimensional graphical representation of the conical surface and plane of transverse curvature for a tapered roller thrust bearing in accordance with an exemplary embodiment; and

FIG. 12 is a graphical representation of the coordinate system used in modeling a tapered roller thrust bearing in accordance with the exemplary embodiment.

FIG. 13 is a graph illustrating tapered roller contact stress versus radial distance from the center of the bearing for a tapered roller thrust bearing with various types of bearing supports;

### DETAILED DESCRIPTION OF PREFERRED EMBODIMENTS

The present embodiments are illustrated as exemplary embodiments that disclose a system for reducing the maximum contact stresses on the tapered rolling elements in a thrust bearing by redistributing the thrust load radially outwardly on the bearing, toward an area of larger cross-sectional diameter of the tapered rolling elements.

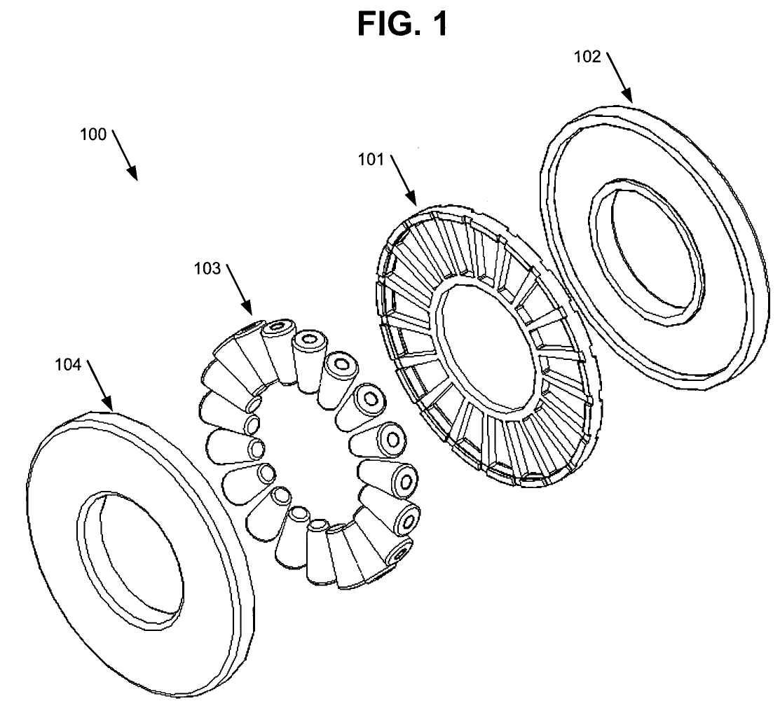

FIG. 1 is an exploded view of a typical tapered roller thrust bearing 100, generally having an upper plate 102 and a bottom plate 104, a plurality of tapered rolling elements 103 and a separator 101. The separator does not affect load distribution in the bearing, and will not appear in the remaining drawings.

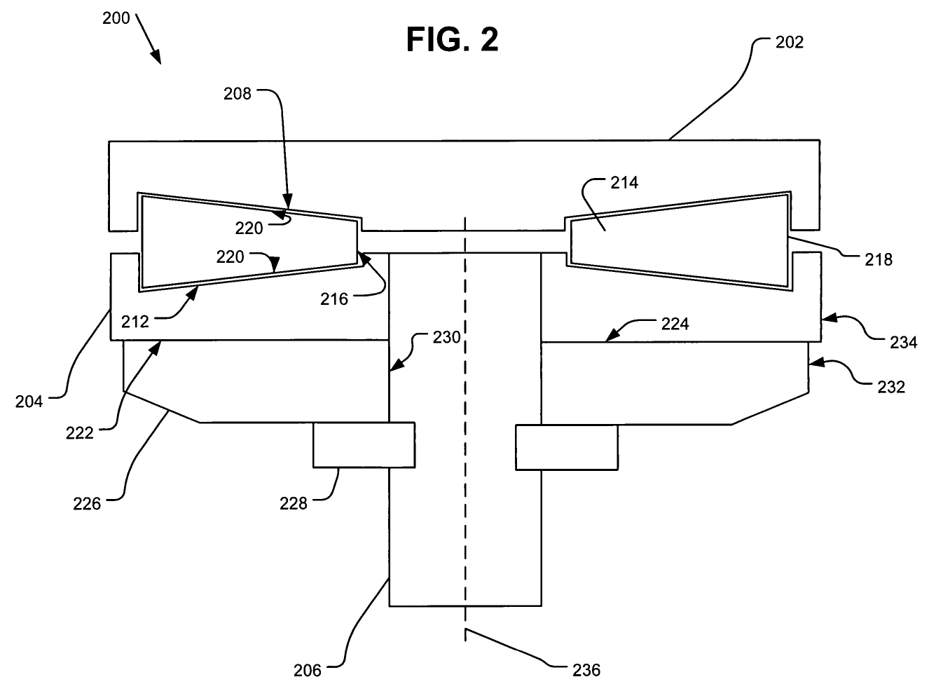

FIG. 2 is a cross-sectional view of a tapered roller thrust bearing 200 generally having an upper plate 202 and a bottom plate 204, shown in an unloaded state with the bottom plate 204 affixed to and positioned about a shaft 206. The upper plate 202 has an upper race 208 and the bottom plate 204 has a bottom race 212. A number of tapered rolling elements 214 are disposed between the upper race 208 and the bottom race 212. The tapered rolling elements 214 are shown shaped like truncated cones with a first end-face 216 having a first diameter, a second opposing end-face 218 having a second, relatively larger diameter, and a rolling surface 220. Of course, the number of tapered rolling elements 214 may vary depending on the bearing application and geometry used. Preferably, the tapered rolling elements 214 rotate on the upper race 208 and the bottom race 212.

The bearing 200 of FIG. 2 shows a bottom surface 222 of the bottom plate 204 resting on the top surface 224 of a backup plate 226. Also shown is a lockring 228 that prevents the backup plate 226 from sliding along the shaft 206. Because the lockring 228 supports the backup plate 226 only near its inner diameter 230, when the bearing 200 is in a loaded state, the backup plate 226 can deflect downward near its outer diameter 232 allowing the bottom plate 204 to also deflect downward near its outer diameter 234. This deflection of the bottom plate 204 can move a portion of the contact pressure between the tapered rolling elements 214 and the upper and bottom races 208, 212 radially inward on the bearing 200 toward the center axis 236 of the bearing 200. Because the cross-sectional diameter of the tapered rolling elements 214 decreases as it approaches the center axis 236 of the bearing 200, the closer to the center axis 236 that a load is applied on the tapered rolling elements 214, the higher the contact stresses in the tapered rolling elements 214 caused by the applied load become. Therefore, a tapered roller thrust bearing 200 that could counter the effects of the deflection of the bottom plate 204 by shifting a portion of the applied load on the tapered rolling elements 214 radially outwardly on the bearing 200 toward a location of larger cross-sectional diameter of the tapered rolling elements 214 would be desirable.

A portion of the load between the tapered rolling elements 214 and the upper and bottom races 208, 212 can be moved radially outwardly on the bearing 200, toward an area of larger cross-sectional diameter of the tapered rolling elements 214, by modifying the interface between the bottom surface 222 of the bottom plate 204 of the bearing 200 and the top surface 224 of the backup plate 226 such that when an axial load is applied to the shaft 206 the areas of highest loading on the tapered rolling elements 214 are shifted more radially outwardly on the bearing 200. Tapering the bottom surface 222 of the bottom plate 204 of the bearing 200 and/or tapering the top surface 224 of the backup plate 226 that contacts the bottom surface 222 of the bottom plate 204 can advantageously result in the areas of highest loading on the tapered rolling element 214 being moved radially outwardly on the bearing 200, toward a location having a larger cross-sectional diameter of the rolling elements 214, thereby reducing the maximum stresses on the rolling elements 214 when the bearing 200 is loaded with an axial thrust load.

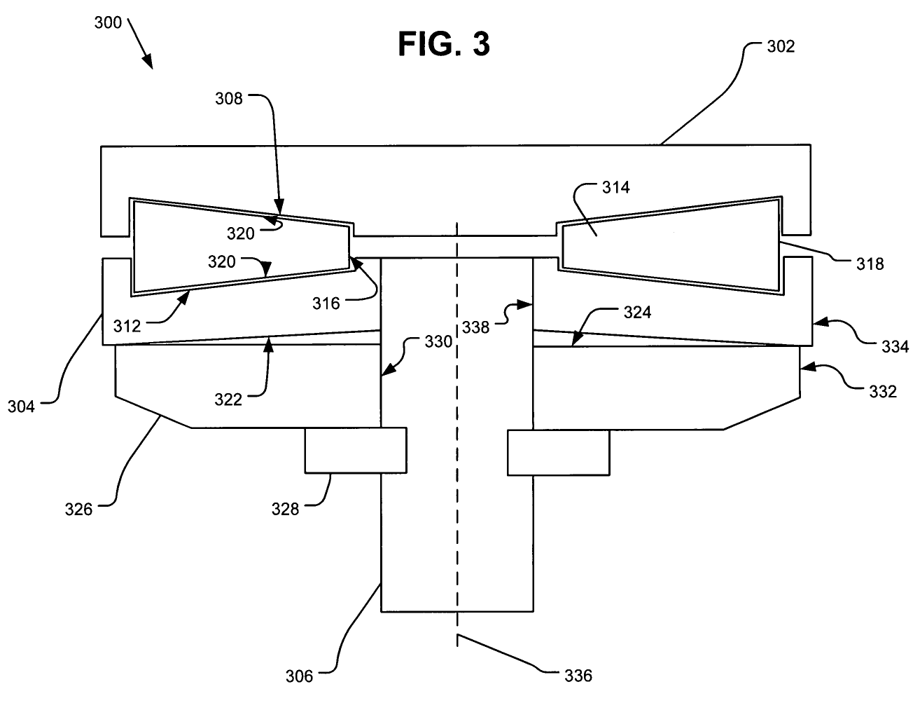

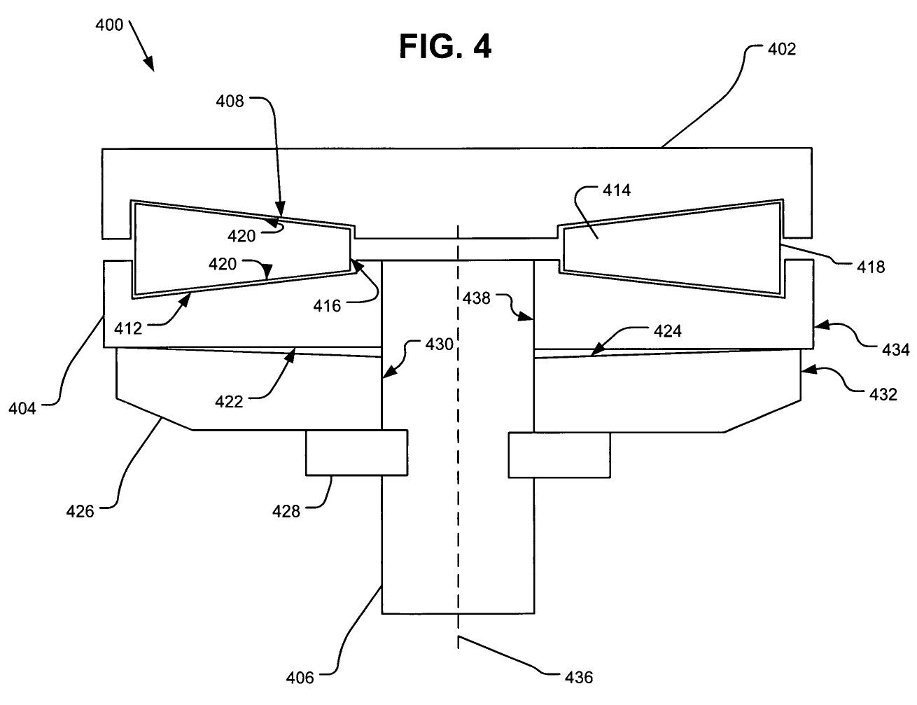

FIG. 3 illustrates a cross-sectional view of an exemplary embodiment of the present invention shown in an unloaded state. The bearing shown in FIG. 3 is the same as that shown in FIG. 2, with the exception that the bottom surface 322 of the bottom plate 304 is tapered from the outer diameter 334 of the bottom plate 304 toward the inner diameter 338 of the bottom plate 304. The bottom surface 322 of the bottom plate 304 can be tapered at an angle α so that an inner portion of the bottom surface 322 of the bottom plate 304 is between 0.003 and 0.015 inches, and ideally 0.012 inches, higher than an outer portion of the bottom surface 322 of bottom plate 304. In the examples for which computations were performed, the shaft measured about 11 inches in diameter, and the bearing had an outside diameter of about 24 inches. Thus, given these dimensions, where the inner portion of the bottom surface 322 of the bottom plate 304 is between 0.003 and 0.015 inches higher than an outer portion of the bottom surface 322 of the bottom plate 304, the corresponding angle α is between 0.03 degrees and 0.13 degrees, and at 0.012 inches, the angle α is 0.11 degrees. Thus, as shown in FIG. 3, as well as the in FIGS. 4, 5, 6A, and 6B, the angle α (and angle β) is exaggerated. The optimal amount by which the thickness of the bottom plate varies from inside to outside depends on the load applied to the bearing as well as on the bearing and support structure dimensions.

When the bearing is loaded with an axial load applied to the shaft 336, this tapered bottom surface 322 of the bottom plate 304 contacts the top surface 324 of the backup plate 326, where the tapered geometry advantageously results in the highest loading on the tapered rolling elements 314 being moved radially outwardly on the bearing 300, toward a location having a larger rolling element 314 cross-sectional diameter, thereby reducing the maximum stresses on the tapered rolling elements 314. As a result, the bearing life and load ratings can be improved.

FIG. 4 also illustrates a cross-sectional view of an exemplary embodiment of the present invention shown in an unloaded state. The bearing 400 shown in FIG. 4, like the bearing 300 in FIG. 3, is the bearing 200 of FIG. 2, but with a modification. The modification of the bearing 400 in FIG. 4 is that the top surface 424 of the backup plate 426 is tapered from its outer diameter 432 toward its inner diameter 430. The top surface 424 of the backup plate 426 can be tapered at an angle β so that an inner portion of the top surface 424 of the backup plate 426 is between 0.001 and 0.015 inches, and ideally 0.012 inches, lower than an outer portion of the top surface 424 of backup plate 426. These dimensions correspond to an angle β ranging from 0.03 degrees to 0.13 degrees, and 0.11 degrees at 0.012 inches.

When the bearing 400 shown in FIG. 4 is loaded with an axial load applied by the shaft 406, the taper of the top surface 424 of the backup plate 426 in FIG. 4 causes the top surface 424 of the backup plate 426 and the bottom surface 422 of the bottom plate 404 to contact each other, wherein the tapered geometry advantageously results in the highest loading on the tapered rolling element 414 being moved radially outwardly on the bearing 400, toward a location having a larger cross-sectional diameter of the rolling elements 414, thereby reducing the maximum contact stresses on the tapered rolling elements 414. This redistribution of the maximum loading on the tapered rolling elements 414 results in a lower maximum stress on the rolling elements 414 which increases the expected life and load rating of the bearing 400.

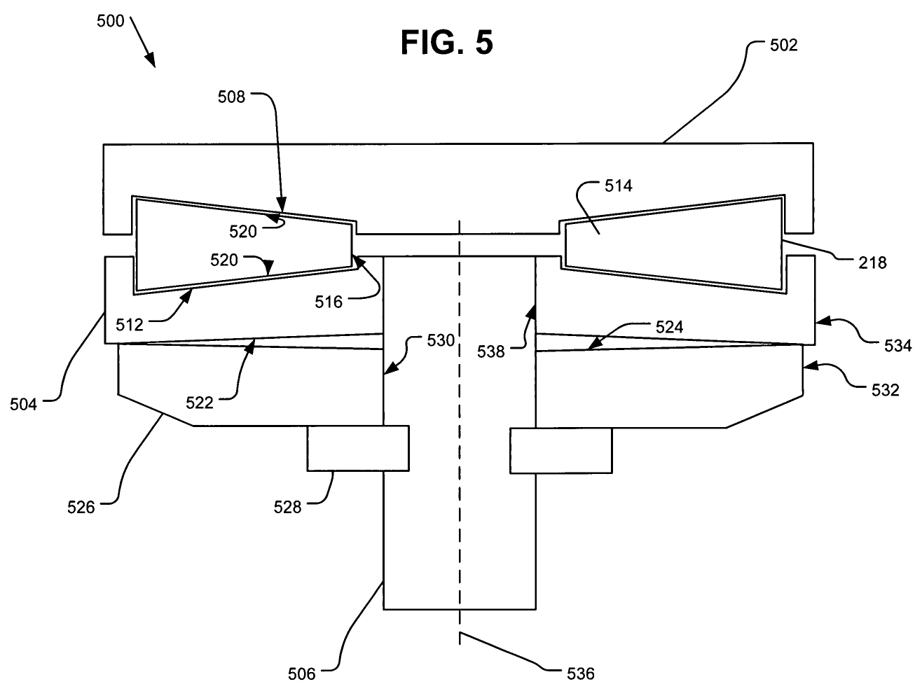

FIG. 5, like FIGS. 3 and 4, illustrates a sectional view of another exemplary embodiment of the present invention. The bearing shown in FIG. 5 is the bearing of FIG. 2, but with two modifications. The modifications of the bearing in FIG. 5 is that the top surface 524 of the backup plate 526 is tapered from its outer diameter 532 toward its inner diameter 530, and the bottom surface 522 of the bottom plate 504 is tapered from its outer diameter 534 toward its inner diameter 538. These tapers are complementary such that when the bearing 500 is loaded with a load applied axially by the shaft 506, the interface of the top surface 524 of the backup plate 526 and the bottom surface 522 of the bottom plate 504 contact each other in such a way as to cause the maximum force applied on the tapered rolling elements 514 to be applied further radially outwardly on the bearing 500 toward a location having a larger tapered rolling element cross-sectional diameter. The result is a lower maximum contact stress on the tapered rolling elements 514 which improves the expected life and load rating of the bearing 500.

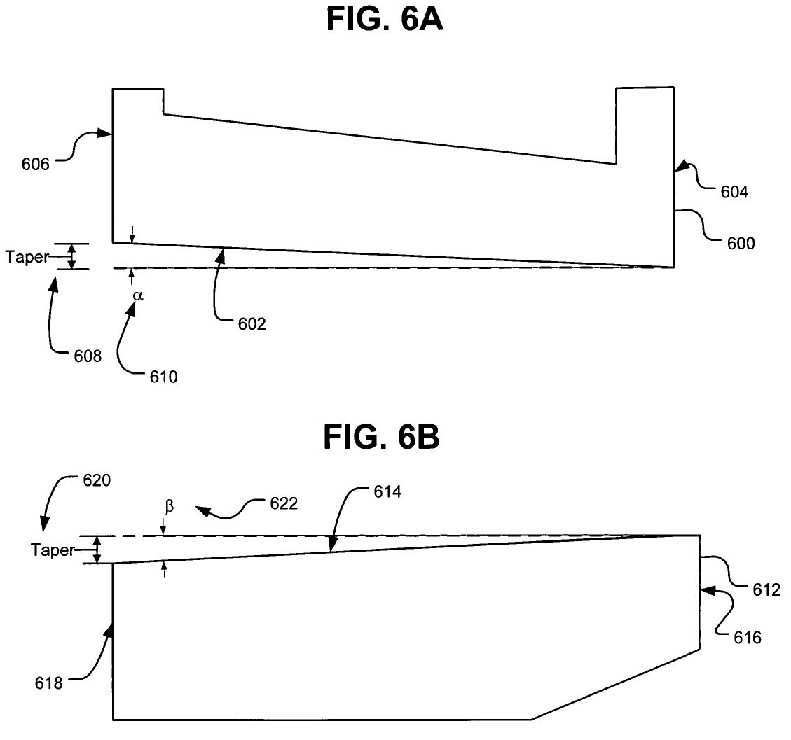

FIG. 6A is a partial cross-sectional view of a bottom plate 600 of a tapered roller thrust bearing in accordance with an exemplary embodiment of the present invention. Like the bearings 300, 500 in FIGS. 3 and 5, the bottom plate 600 of FIG. 6A has a bottom surface 602 that is tapered from its outer diameter 604 toward its inner diameter 606. The taper 608 is such that the bottom surface 602 of the bottom plate 600 contacts a top surface of a backup plate in a complementary manner so as to shift the areas of maximum loading on the tapered rolling elements more radially outwardly on the bearing toward a location having a larger cross-sectional diameter of the tapered rolling elements. The bottom surface 602 of the bottom plate 600 is tapered at an angle α 610 so that an inner portion of the bottom surface 602 of the bottom plate 600 is between 0.001 and 0.015 inches, and ideally 0.012 inches, higher than an outer portion of the bottom surface 602 of bottom plate 600

FIG. 6B is a partial sectional view of a backup plate 612 for a tapered roller thrust bearing in accordance with an exemplary embodiment of the present invention. Like the backup plates 426, 526 in FIGS. 4 and 5, the backup plate 612 of FIG. 6B has a top surface 614 that is tapered from its outer diameter 616 toward its inner diameter 618. The taper 620 is such that a the top surface 614 of the backup plate 612 contacts a bottom surface of a bottom plate of a tapered roller thrust bearing in a complementary manner so as to shift the areas of maximum loading on the tapered rolling elements more radially outwardly on the bearing toward an area of larger radius of curvature of the tapered rolling elements. The top surface 614 of the backup plate 612 is tapered at an angle β 622 so that an outer portion of the top surface 614 of the backup plate 612 is between 0.001 and 0.015 inches, and ideally 0.012 inches, lower than an inner portion of the top surface 614 of the backup plate 612.

Bearing Modeling

a. Overview

In order to demonstrate the efficacy of the improvements described herein, and to determine the amount of tapering that will work most effectively for a particular bearing, commercially available finite element analysis (FEA) software packages can calculate the distribution of load acting on the rolling elements for different configurations of the bearing. Such software packages can model physical structures by discretizing them into a number of finite elements and analyzing the forces acting on those individual elements in order to determine the effect of the forces on the object as a whole. Commercially available ANSYS software enabled performance of the finite element method analyses in this study.

b. Modeling Results for Rigidly Supported Bearing

The bottom plate in this model rested on a rigid support. This preliminary model therefore analyzed the performance of a rigidly supported tapered roller thrust bearing. The model results for the rigidly supported tapered roller thrust bearing can later be compared to the model results for the bearing supported by the actual support structure.

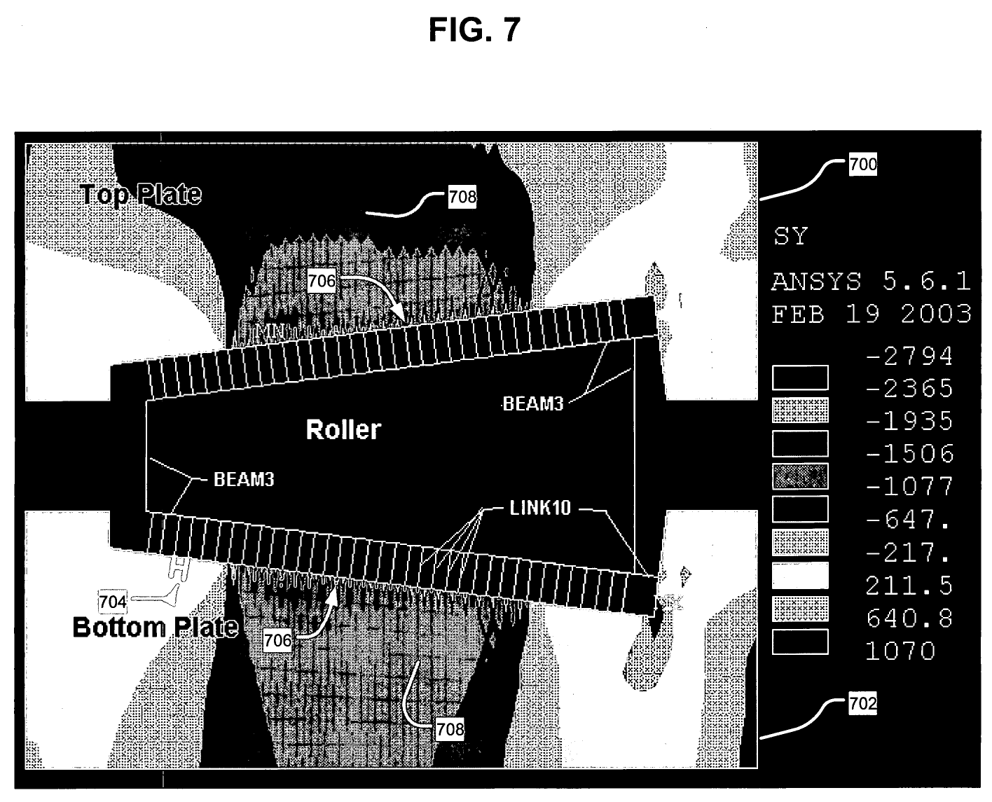

FIG. 7 illustrates, as a contour plot, the distribution of compressive stress in the top and bottom plates 700, 702.

c. Modeling Results for Imperfectly Supported Bearing

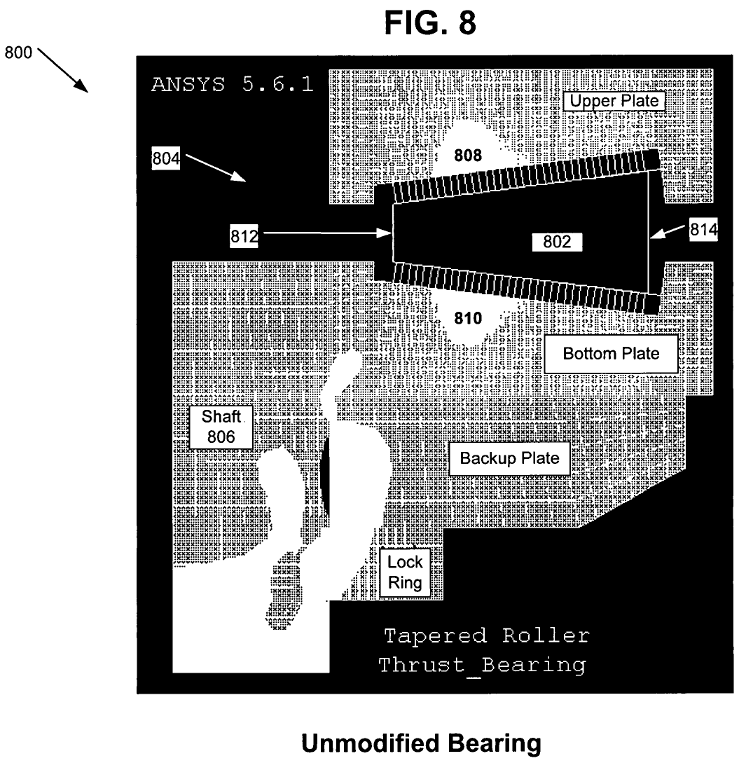

FIG. 8 shows the results 800 of a finite element method analysis of the loading on a tapered rolling element 802 of an unmodified tapered roller thrust bearing 804 of the type illustrated in FIG. 2, with an axial load applied to the shaft 806. The analysis shows the locations of the areas of maximum loading on the tapered rolling element 802, by illustrating solid areas 808 and 810. As FIG. 8 illustrates, the location of the areas of maximum loading 808, 810 are located closer to the first end 812, or smaller cross-sectional diameter end of the tapered rolling element 802 than to the second end 814, or larger diameter end. The goal of the present invention is to move the areas of highest loading 808, 810 more radially outwardly on the bearing 804 toward an area of larger cross-sectional diameter of the tapered rolling element 802, thereby reducing the maximum stress on the tapered rolling element 802.

d. Modeling Results for Imperfectly Supported Bearing of Improved Type

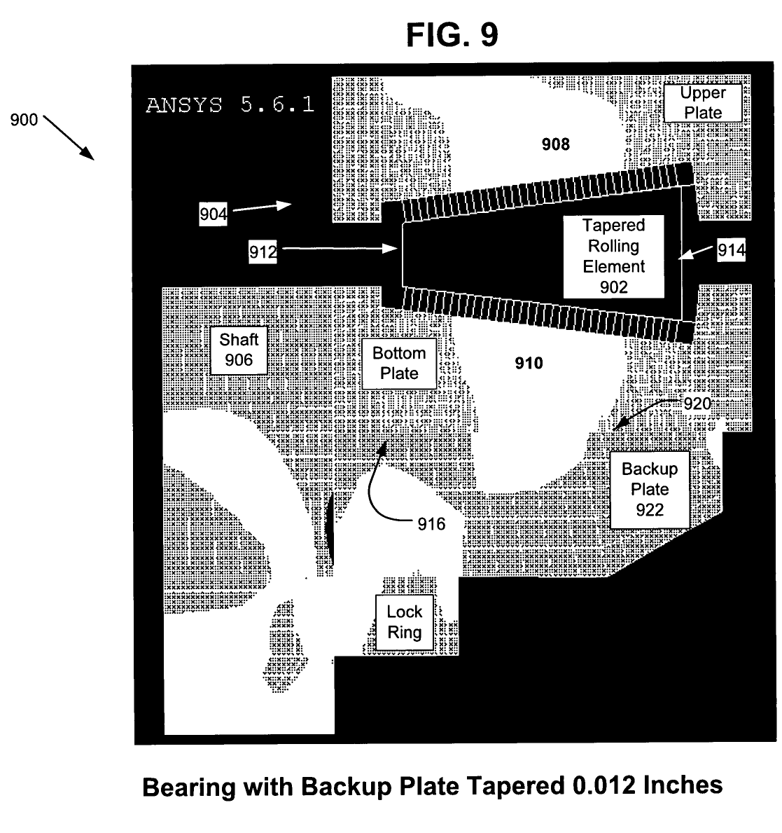

FIG. 9 shows the results 900 of a finite element method analysis on the loading of a tapered rolling element for the modified tapered roller thrust bearing 400, illustrated in FIG. 4. Like the bearing 400 in FIG. 4, the bearing 904 analyzed in FIG. 9 has the bottom surface 920 of its bottom plate 918 in contact with a backup plate 922 having a top surface 916 tapered such that at an inner portion of the backup plate 922 is 0.012 inches lower than an outer portion of the top surface of the backup plate. Like the unmodified tapered roller thrust bearing 804 analyzed in FIG. 8, the bearing 904 analyzed in FIG. 9 has a thrust load applied by its attached shaft 906. The finite element method analysis was performed using commercially available ANSYS software.

Compared to the finite element analysis results shown in FIG. 8 for the unmodified bearing of FIG. 2, the loading results for the bearing of FIG. 4, shown in FIG. 9, illustrate how the tapered top surface 916 of the backup plate 922 caused the areas of maximum loading 908, 910 on the tapered rolling element 902 to be more evenly distributed and shifted more radially outwardly on the bearing 904 to an area of larger cross-sectional diameter of the tapered rolling element 902. This more evenly distributed loading and shifted areas of maximum tapered rolling element loading 908, 910 to an area of larger radius of curvature on the tapered roller bearings 902 reduces the maximum contact stress on the tapered rolling elements 902, and as a result, increases the bearing's expected life and load rating. Models were analyzed for tapers ranging from zero to 0.015 inches, in 0.003 inch increments. Similar results would be expected for bearings modified as illustrated in FIGS. 3 and 5.

e. Comparison of Modeling Results for Contact Force Distribution

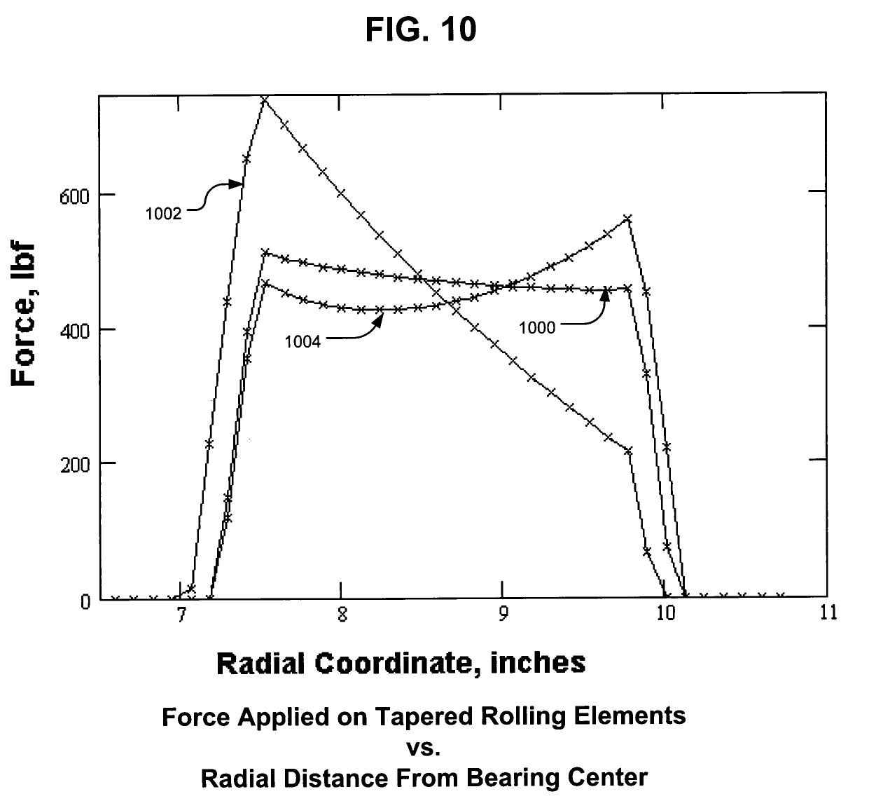

The finite element analyses of the previous paragraphs provide as output not only the distribution of stresses in the bearing plates, but also the distribution of contact forces along the lines of contact between rolling element and raceways. FIG. 10 shows three graphical plots 1000, 1002, 1004 illustrating roller load versus radial distance from the center of a tapered roller thrust bearing, for a rigidly supported bearing, a bearing in contact with an unmodified backup plate, and a bearing in contact with a backup plate having its top surface tapered such that an inner portion of its top surface is 0.012 inches lower than an outer portion of its top surface. The first plot 1000, for the rigidly supported bearing, shows that the load on the tapered rolling elements is fairly evenly distributed along the length of the rolling elements, with the greatest load being applied to the rolling elements at between seven and eight radial inches. The second plot 1002, for the unmodified bearing, shows that the load varies significantly along the length of the rolling element with the greatest load applied between seven and eight radial inches. The greatest load for the unmodified bearing is located in substantially the same area as the greatest load for the rigidly supported bearing, and is nearly twice the magnitude of the greatest load for the rigidly supported bearing. The third plot 1004, for the bearing contacting the backup plate having its top surface tapered such that an inner portion of the top surface is 0.0012 inches lower than an outer portion of the top surface shows that the loading on the bearing is fairly evenly distributed with its highest magnitude being located at approximately ten radial inches from the center of the bearing, in a location of larger radius of curvature on the tapered rolling elements than the radius at the highest magnitude load acting on the rigidly supported and unmodified bearing's tapered rolling elements.

Calculation of Contact Stress

a. Mathematical Basis

Calculation of the contact stresses and subsequent calculation of the stresses' effect on bearing life serves to evaluate the effect of the load distribution along the rolling element. Calculation of contact stress requires knowledge of the principal curvatures of the roller and of the bearing plate, each of which has a conical shape. Calculation of stress also requires the actual length for the contact. The finite element method analyses provide force exerted on each short length of roller, or lamina, in contact with an equal length of bearing plate. The length of the lamina in contact depends on the slope of the conical surface of the bearing plate as in the equation:

$${L}_{slope} = \frac{{L}_{axial}}{cos ( α )}$$

Where α denotes the complement of one-half the included angle at the cone vertex, and Lₐₓᵢₐₗ denotes the length of the lamina, measured parallel to the axis of the roller.

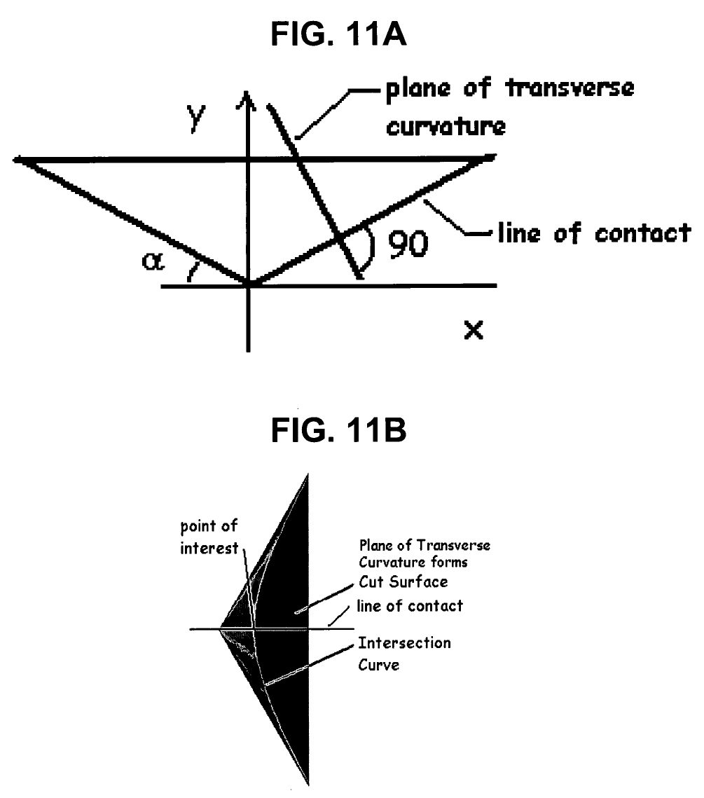

Along the line of contact, the roller and raceway have zero curvature, or infinite radius of curvature. The other principal axis of curvature lies in the plane of transverse curvature, which plane lies perpendicular to the conical surface of the roller or bearing plate. FIG. 11A shows a two-dimensional schematic of the conical surface, line of contact, and plane of transverse curvature. FIG. 11B shows a three-dimensional schematic of the conical surface and the plane of transverse curvature. The intersection of the plane of transverse curvature and the surface of the cone forms a parabola. The curvature of this parabola at its intersection with the line of contact governs the stress at the point of interest. The equation:
y²=k²(x²+y²)
defines the conical surface, where k=tan(α). The equation:

$$y - {y}_{o} = ( - \frac{1}{k} ) ( x - {x}_{o} )$$

defines the planar surface, where (x₀, y₀) denotes the point where the surfaces intersect in the x-y plane. The parameter x₀ also denotes the radial distance of the point of interest from the axis of the bearing.

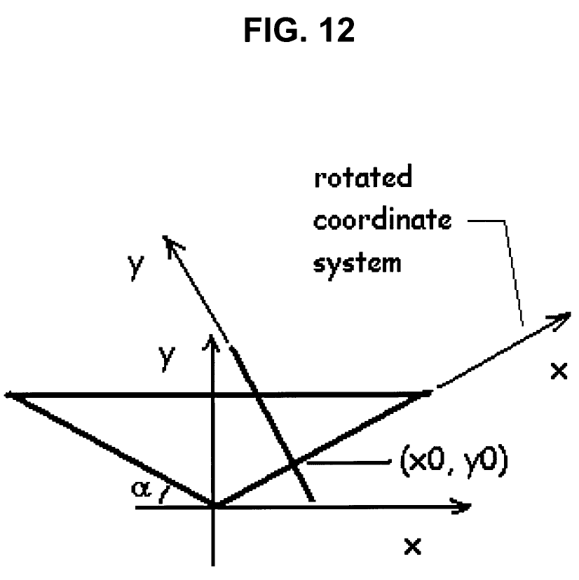

FIG. 12 shows a coordinate system in which the equation of the plane becomes x=0. By translating the origin to (x₀, y₀) and rotating through the angle α, the equation for the cone becomes:
(x sin(α)+y cos(α)+y₀)²=k²└(x cos(α)−y sin(α)+x₀)²+z²┘
Substituting x=0 into the equation for the cone gives the equation for the curve of intersection of the cone and plane:
(ycos(α)+y₀)²=k²|(x₀−ysin(α))²+z²|
Manipulating this last result produces an expression of the form:
(y+c₃)²=c₄z²+c₃²
where c₃ and c₄ depend on α and x₀.

To find the local radius of curvature requires evaluating the following expression at x=x₀, y=y₀:

$$r = \frac{{[ 1 + {( \frac{ⅆ y}{ⅆ z} )}^{2} ]}^{\frac{3}{2}}}{\frac{{ⅆ}^{2} y}{ⅆ {z}^{2}}}$$

This equation evaluates to:

$${r}_{race} = \frac{{x}_{o}}{sin ( α )}$$

where r_{race} is the local radius of curvature at the point (x₀, y₀) of the conical bearing plate in the direction transverse to the line of contact. A similar analysis for the conical roller shows:

$${r}_{roller} = \frac{{y}_{o}}{cos ( α )}$$

The method implemented in the ANSYS finite element model calculates the distribution of load over the length of the roller. Having the load per unit length and the principal curvatures as a function of the location along the line of contact allows calculation of the contact stress. The contact stress increases with the reciprocal of the curvature sum:

$$\sum p = ( \frac{1}{{r}_{race}} ) + ( \frac{1}{{r}_{roller}} )$$

Substituting the curvature radii into the curvature sum:

$$\sum p = ( \frac{sin ( α )}{{x}_{o}} ) + ( \frac{cos ( α )}{{y}_{o}} )$$

But,
y₀=x₀ tan(α)
so the curvature sum gets expressed in terms of the cone angle and distance from the bearing axis,

$$\sum p = \frac{1}{( {x}_{o} sin ( α ) )}$$

The maximum contact stress in a line contact,

$$σ = \sqrt{\frac{F \times \sum p}{π \times L \times C}}$$

where F denotes load, L denotes length of the contact, and C includes material elastic properties. Substituting for the curvature ratio and for the length of the lamina in contact,

$$σ = \sqrt{\frac{F}{π \times {x}_{o} \times sin ( α ) \times {L}_{slope} \times C}}$$

This equation shows that, all else constant, the contact stress will decrease along the conical roller/plate contact as

$$\frac{1}{\sqrt{{x}_{o}}} .$$

Recalling that x₀ measures radial distance from the bearing axis, a bearing that distributes load radially outwardly will have lower maximum contact stress.

b. Contact Stress for Tapered Roller Bearings

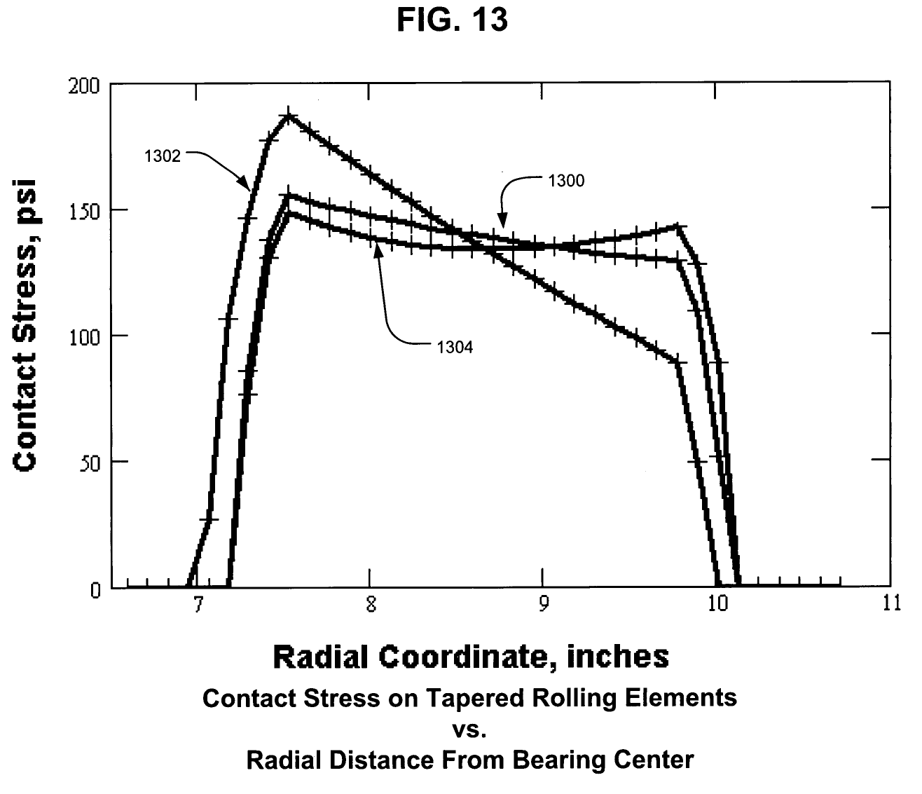

FIG. 13 is a graphical plot of contact stresses on the tapered rolling elements of a tapered roller thrust bearing versus radial inches from the center of the bearing. FIG. 13 shows contact stress (σ) in pounds-per-square-inch versus radial coordinates of the bearing (x₀), i.e. the distribution of contact stress along the length of the contact between the roller and the bearing bottom plate. FIG. 13 has three curves for the bearing in combination with three different support structures. The first plot 1300 illustrates the contact stresses on the tapered rolling elements for a rigidly supported bearing, the second plot 1302 illustrates the contact stresses for the unmodified bearing, and the third plot 1304 illustrates the contact stresses for the bearing in contact with a backup plate having its top surface tapered such that an inner portion of the top surface is 0.012 inches lower than an outer portion of the top surface. The plot illustrates that the tapered rolling elements of a bearing that is in contact with the tapered backup plate have a maximum contact stress that is lower than that of tapered rolling elements in a rigidly supported bearing and lower than that of tapered rolling elements in an unmodified bearing. As a result, the bearing that is in contact with the tapered backup plate should have the highest load rating and expected life of the three bearings.

To reiterate, the bearing having no tapering develops the highest contact stress. The rigidly supported bearing, with the most evenly distributed load, nonetheless develops higher maximum stress than the bearing with backup plate tapered by 0.012 inches. While the rigidly supported bearing distributes load most evenly along the contact, the 0.012 inch tapered bearing distributes load to outboard regions of low roller and plate curvature, and therefore distributes stress most evenly, and develops the lowest maximum stress.

c. Additional Comparison Case: Contact Stress for Cylindrical Roller Bearing

Because the curvature sum Σρ does not change with location along the lines of contact in a cylindrical roller bearing, the relationship:

$$σ = \sqrt{\frac{F \sum ρ}{π \times L \times C}}$$

can be used to calculate the maximum contact stress in the cylindrical roller bearing. This stress can be used to roughly check the magnitude of the calculated stresses for the tapered roller bearing. The rollers of the cylindrical roller bearing had curvature equal to the average curvature of the tapered rollers. Table 1 below, “Contact Pressures and Lives”, reports the stress for this approximately equivalent cylindrical roller bearing.
Calculation of Rolling Contact Fatigue Life

Roller bearings fail by a mechanism known as rolling contact fatigue. The life of a roller bearing depends on the contact stress in the bearing, as shown by the proportionality L∝σ⁸. To find the ratio of the life of a bearing to the life of a benchmark bearing, one takes the ratio of the contact stresses in the bearings to the eighth power. Taking the rigidly supported bearing as the benchmark case, Table 1 shows the relative lives of the bearing as installed on support structures having various amounts of tapering of the backup plate. The table also shows the contact stress for a roughly equivalent cylindrical roller bearing described above.

TABLE 1
Contact Pressures and Bearing Life

| Tapering | Max Contact Pressure | |
|---|---|---|
| (inches) | (ksi) | Relative Life |
| Cylindrical | 145 | |
| Rigid Support | 159 | 1 |
| 0.000 | 187 | 0.27 |
| 0.003 | 177 | 0.42 |
| 0.006 | 166 | 0.71 |
| 0.009 | 157 | 1.11 |
| 0.012 | 148 | 1.77 |
| 0.015 | 151 | 1.51 |

The stresses for the tapered roller bearing cases all have the same order of magnitude as the stress for the cylindrical roller bearing of roughly equivalent dimension.

The bearing on the support structure with 0.000 inch tapering attains only 27% of the benchmark life, while the bearing on the support structure with 0.012 inches of tapering attains 177% of the benchmark life. In other words, careful selection of the amount of tapering increases the bearing life by 6.5 times over the case of no tapering.

The present embodiments, described herein as exemplary embodiments, provide the ability to more effectively distribute the load on each tapered rolling element of a tapered roller thrust bearing by moving the peak loading more radially outwardly on the bearing, to a location of larger cross-sectional diameter of the tapered rolling elements to reduce maximum tapered roller contact stress in a cost effective and efficient manner. The present embodiments utilize a tapered bottom surface of a bottom plate and/or a tapered top surface of a backup plate.

It should be understood that the systems described herein are not limited to any particular type or size of tapered rolling element thrust bearing. Various types of general purpose or specialized tapered rolling element thrust bearings may be used in accordance with the teachings described herein.

In view of the wide variety of embodiments to which the principles of the present invention can be applied, it should be understood that the illustrated embodiments are exemplary only, and should not be taken as limiting the scope of the present invention. For example, more or fewer elements may be used in the diagrams, and bearings of various sizes and dimensions may be utilized in accordance with the teachings herein.

The claims should not be read as limited to the described order or elements unless stated to that effect. Therefore, all embodiments that come within the scope and spirit of the following claims and equivalents thereto are claimed as the invention.

What is claimed is:

1. A bearing comprising:
an upper plate having an upper race;
a bottom plate having an bottom race, and a bottom surface; and
a plurality of tapered rolling elements each having a rolling surface, a first end, and a second end, wherein the plurality of tapered rolling elements is disposed between the upper race and the bottom race;
wherein the bottom surface of the bottom plate is tapered at an angle α.

2. The bearing of claim 1 wherein the angle α is such that an inner portion of the bottom surface of the bottom plate is between about 0.003 inches and 0.015 inches higher than an outer portion of the bottom surface of the bottom plate.

3. The bearing of claim 2 wherein the angle α is such that the inner portion of the bottom surface of the bottom plate is preferably about 0.012 inches higher than the outer portion of the bottom surface of the bottom plate.

4. The bearing of claim 1 wherein the angle alpha is between 0.03 and 0.13 degrees.

5. The bearing of claim 4 wherein the angle alpha is about 0.11 degrees.

6. A bearing assembly comprising:
an upper plate having an upper race;
a bottom plate having a bottom race, and a bottom surface;
a plurality of tapered rolling elements each having a rolling surface, a first end, and a second end, wherein the plurality of tapered rolling elements is disposed between the upper race and the bottom race; and
a bearing support having a top surface that contacts the bottom surface of the bottom plate;
wherein the interface between the bottom surface of the bottom plate and the top surface of the bearing support is such that a portion of a thrust load acting on the rolling surface of the plurality of tapered rolling elements is moved radially outwardly.

7. The bearing of claim 6 wherein the top surface of the bearing support is tapered at an angle α.

8. The bearing of claim 7 wherein the angle α is such that an inner portion of the top surface of the bearing support is between about 0.003 inches and 0.015 inches lower than an outer portion of the top surface of the bearing support.

9. The bearing of claim 8 wherein the angle α is such that the inner portion of the top surface of the bearing support is about 0.012 inches lower than the outer portion of the top surface of the bearing support.

10. The bearing of claim 6 wherein the bottom surface of the bottom plate is tapered at an angle α.

11. The bearing of claim 10 wherein the angle α is such that an inner portion of the bottom surface of the bottom plate is between about 0.003 inches and 0.015 inches higher than an outer portion of the bottom surface.

12. The bearing of claim 11 wherein the angle α is such that the inner portion of the bottom surface of the bottom plate is about 0.012 inches higher than the outer portion of the bottom surface.

13. The bearing of claim 6 wherein the top surface of the bearing support is tapered at an angle α and the bottom surface of the bottom plate is tapered at an angle β.

14. The bearing of claim 13 wherein the angle β is such that an inner portion of the bottom surface of the bottom plate is about X inches higher than an outer portion of the bottom surface;
the angle α is such that an inner portion of the top surface of the backup plate is about Y inches lower than an outer portion of the top surface; and
the sum of X and Y equals between about 0.003 inches and 0.015 inches.

15. The bearing of claim 14 wherein the sum of X and Y equals about 0.012 inches.

16. The bearing of claim 6 wherein the bearing support comprises a backup plate.

17. The bearing of claim 16 wherein the bearing support further comprises a lockring.

18. A bearing support comprising:
a backup plate having a top surface;
wherein the top surface is tapered at an angle β so that an interface between the top surface of the backup plate and a tapered roller thrust bearing is such that a portion of a thrust load acting on a rolling surface of a plurality of tapered rolling elements of the tapered rolling element thrust bearing is moved radially outwardly.

19. The bearing support of claim 18 wherein the angle β is such that an inner portion of the bottom surface of the backup plate is between about 0.003 inches and 0.015 inches higher than an outer portion of the bottom surface of the backup plate.

20. The bearing support of claim 19 wherein the angle α is such that the inner portion of the bottom surface of the backup plate is reduced by about 0.012 inches at its inner diameter.

21. The bearing support of claim 18 wherein the bearing support comprises a backup plate.

22. The bearing support of claim 21 wherein the bearing support further comprises a lockring.

23. The bearing support of claim 18, wherein the angle β is between 0.03 and 0.13 degrees.

24. The bearing support of claim 18, wherein the angle β is about 0.11 degrees.
